(19) United States
(12) Patent Application Publication
(10) Pub. No.: US 2014/0377544 A1
(43) Pub. Date: Dec. 25, 2014

(54) COMPOSITE MATERIAL, METHOD FOR PREPARING THEREOF, AND SUBSTRATE USING THE SAME

(71) Applicant: SAMSUNG ELECTRO-MECHANICS CO., LTD., Suwon (KR)

(72) Inventors: Ye Jun PARK, Hwasung (KR); Jun Young KIM, Suwon (KR); Jung Wook SEO, Hwasung (KR); Jun Hyeon KIM, Suwon (KR); Byung Kun KIM, Seoul (KR)

(73) Assignee: SAMSUNG ELECTRO-MECHANICS CO., LTD., Suwon (KR)

(21) Appl. No.: 14/044,392

(22) Filed: Oct. 2, 2013

(30) Foreign Application Priority Data
Jun. 25, 2013 (KR) 10-2013-0073013

(51) Int. Cl. C08K 3/36

(52) U.S. Cl. CPC C08K 3/36
USPC 428/332; 252/62; 427/387

(57) ABSTRACT

Disclosed herein are a composite material including an anisotropic filler and a component having directionality, wherein the component having directionality has a length in a range of 1.5 to 20 based on a length of the anisotropic filler, a method for preparing thereof, and a substrate using the same as an insulation layer. According to the exemplary embodiment of the present invention, in the composite material using the anisotropic filler, the component having directionality is used for controlling the dispersion directionality of the anisotropic filler, whereby at the time of orientation of the component having directionality, the directionality in which the anisotropic filler is dispersed may be controlled to improve the dispersion of the anisotropic filler.

### CROSS REFERENCE(S) TO RELATED APPLICATIONS

This application claims the benefit under 35 U.S.C. Section 119 of Korean Patent Application Serial No. 10-2013-0073013, entitled “Composite Material, Method for Preparing Thereof, and Substrate Using The Same” filed on Jun. 25, 2013, which is hereby incorporated by reference in its entirety into this application.

### BACKGROUND OF THE INVENTION

1. Technical Field The present invention relates to a composite material, a method for preparing thereof, and a substrate using the same as an insulation layer.

2. Description of the Related Art

An insulation film for a substrate material is capable of being fabricated by mixing a resin and a filler. The filler may be contained in order to improve physical properties such as insulation property, mechanical strength, coefficient of thermal expansion, and the like, and a compound such as SiO₂, or the like, may be generally used for the filler.

In particular, processes such as lamination, fabrication, and the like, are performed for forming a circuit of a multilayer substrate. The processes accompany change in temperature (300 or lower), and according to the temperature, the coefficient of thermal expansion of an insulation composite material is also changed to cause defects including change in a shape such as a dent, warpage, or the like, of the insulation film.

Therefore, in order to improve yield at the time of manufacturing the substrate and manufacture a highly integrated/thinned substrate for new generation, coefficient of thermal expansion of the composite material and stress release in the process are an important matter.

An insulation layer is mainly made of the composite material of the filler and the resin, wherein each of the coefficients of thermal expansion of the filler material and the resin material has an influence on properties of the insulation layer. Since the coefficient of thermal expansion of an organic material resin is generally larger than that of an inorganic material filler, it is advantageous to increase a content (filling rate) of the filler.

In addition, as the content of the inorganic filler become increased, it becomes more important to decrease thermal expansion of the filler material itself.

Further, stiffness of the insulation layer is important as compared to a thickness thereof in order to allow the insulation layer to be thinned. The stiffness is varied according to a shape even in the same material, and the required stiffness is capable of being secured by changing the shape of the applied filler from an isotropic spherical shape (having a symmetric structure) to an anisotropic filler having an asymmetric structure.

However, the isotropic spherical filler is capable of being filled regardless of a direction to have an advantage in filling, and the anisotropic filler having directionality has excellent stiffness but is dispersed without the direction due to characteristics of a shape thereof as shown in FIG. 1, to thereby have a disadvantage in filling, such that it is easy to decrease a filling rate of the filler in the composite material, and the coefficient of thermal expansion of the composite material is high, thereby causing the defect such as the dent, the warpage, or the like, of the film.

Therefore, in using the anisotropic filler in order to increase the stiffness of the insulation layer, a method capable of increasing the filling rate of the filler by controlling the dispersion property of the anisotropic filler is required.

### RELATED ART DOCUMENT

### Patent Document

(Patent Document 1) Japanese Patent Laid-Open Publication No. 10-2012-040811

### SUMMARY OF THE INVENTION

An object of the present invention is to provide a composite material capable of maintaining stiffness of an anisotropic filler and improving a filling rate of the filler by appropriately controlling directionality in which the anisotropic filler is dispersed in an insulation composite material using the anisotropic filler as an inorganic filler.

In addition, another object of the present invention is to provide a method for preparing the composite material.

Further, another object of the present invention is to provide a substrate using the composite material as an insulation layer.

According to a first exemplary embodiment of the present invention, there is provided a composite material including: an anisotropic filler; and a component having directionality, wherein the component having directionality has a length in a range of 1.5 to 20 based on a length of the anisotropic filler.

The anisotropic filler may have an asymmetric structure.

The anisotropic filler may have an aspect ratio of 1.5 to 100.

The anisotropic filler may have a diameter of 0.01 to 1.0 m.

The anisotropic filler may be at least one selected from a group consisting of SiO₂, Al₂O₃, ZrO₂, ZnO, BaO, CaO, MgO, and SrO.

The component having directionality may be at least one selected from a liquid crystal polymer and a liquid crystal oligomer.

The component having directionality may control directionality in which the anisotropic filler is dispersed.

According to a second exemplary embodiment of the present invention, there is provided a method for preparing a composite material including: mixing an anisotropic filler and a component having directionality; applying the mixture on a film and controlling directionality in which the anisotropic filler is dispersed; and curing the applied film.

The component having directionality may have a length in a range of 1.5 to 20 based on a length of the anisotropic filler.

According to a third exemplary embodiment of the present invention, there is provided a substrate using an insulation layer including the composite material as described above.

The insulation layer may have a thickness of 5 to 50 μm. The insulation layer may satisfy a coefficient of thermal expansion of 0 to 50 ppm/K.

### BRIEF DESCRIPTION OF THE DRAWINGS

FIG. 1 is a view showing a case in which anisotropic fillers according to the related art are dispersed without directionality; and

FIG. 2 is a view showing a case in which at the time of mixing components having directionality and anisotropic filler according to the exemplary embodiment of the present invention, the components having directionality are dispersed by controlling the directionality in which the anisotropic filler is dispersed.

### DESCRIPTION OF THE PREFERRED EMBODIMENTS

Hereinafter, the present invention will be described in more detail.

Terms used in the present specification are for explaining specific exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to a composite material contained in the insulation layer of a substrate, or the like, a method for preparing thereof, and a substrate using the same as an insulation layer.

In particular, the present invention is characterized in that the insulation layer containing an anisotropic filler as an inorganic material contains a component having directionality together with the anisotropic filler, wherein a length of the component having directionality is specified so as to control the directionality in which the anisotropic filler is dispersed.

That is, the composite material according to the exemplary embodiment of the present invention includes the anisotropic filler and the component having directionality, and the component having directionality has the length in a range of 1.5 to 20 based on a length of the anisotropic filler.

The ‘anisotropic filler’ according to the exemplary embodiment of the present invention does not have a symmetric structure like a spherical isotropic filler, but has an asymmetric structure like a filler having a rod shape or a wire, and the rod type or the wire is represented as an example of the anisotropic fillers according to the exemplary embodiment of the present invention, but the present invention is not limited thereto.

In the exemplary embodiment of the present invention, the anisotropic filler has an aspect ratio of 1.5 to an unlimited value (∞), preferably, 1.5 to 100, which is favorable to secure shear modulus of the insulation film.

The anisotropic filler according to the exemplary embodiment of the present invention may contain all of the general inorganic fillers satisfying the above-described range of the aspect ratio, and for example, the anisotropic filler may be at least one selected from a group consisting of SiO₂, Al₂O₃, ZrO₂, ZnO, BaO, CaO, MgO, and SrO, but the present invention is not specifically limited thereto.

In addition, a particle size of the anisotropic filler according to the exemplary embodiment of the present invention may have a diameter of 0.01 to 1.0m, and the anisotropic filler having a thickness of 1/10 or less based on the thickness of the insulation film may be used.

In the present invention, in using an inorganic filler as the anisotropic filler, a component having directionality is used in order to control the direction in which the anisotropic filler is dispersed.

Here, ‘the component having directionality’ includes a group that is not bent but has excellent linear property such as a biphenyl unit, and examples of the component having directionality may include a liquid crystal oligomer, a liquid crystal polymer, or the like, but the component having directionality is not limited to the biphenyl unit, but any component may be used as long as it has a liquid crystal property.

The component having directionality according to the exemplary embodiment of the present invention is a material having a property in which it is orientated in a predetermined direction over a predetermined temperature or concentration. Therefore, as the component having directionality is orientated, the directionality in which the anisotropic inorganic filler is dispersed may also be controlled.

In particular, it is preferred that the component having directionality according to the exemplary embodiment of the present invention has a length in a range of 1.5 to 20 based on the length of the anisotropic filler to thereby control the directionality in which the anisotropic filler is dispersed. In the case in which the length of the component having directionality based on the length of the anisotropic filler is less than 1.5, since the length of the component based on the length of the anisotropic filler is short, the directionality in which the anisotropic filler is dispersed may not be controlled, such that a filling rate of the anisotropic filler may not be increased. In addition, in the case in which the length of the component having directionality based on the length of the anisotropic filler is more than 20, since the length of the component having directionality is significantly long, it may have a problem in solubility, such that dispersibility may be deteriorated, which is not preferred.

Referring to FIG. 2 showing the case in which when the component having directionality and the anisotropic filler are mixed to be used, the component having directionality is dispersed while controlling the directionality in which the anisotropic filler is dispersed, a material having a predetermined length or longer so that the component 10 having directionality has the length in the range of 1.5 to 20 based on the length of the anisotropic filler 20 is used, whereby the component 10 having directionality may control the directionality in which the anisotropic filler 20 is dispersed while the component is orientated in a predetermined direction.

Therefore, in the exemplary embodiment of the present invention, the anisotropic filler may be used to secure a stiffness, and the dispersibility of the anisotropic filler may be improved to increase the filling rate.

In the exemplary embodiment of the present invention, a base resin configuring the insulation layer, a solvent, and a dispersant may be further included in addition to the anisotropic filler and the component having directionality, wherein kinds of base resin, the solvent, and the dispersant, and the contents thereof are not particularly limited, but may be included to the extent that is used in the insulation layer of the general substrate.

The composite material according to the exemplary embodiment of the present invention may be prepared by mixing the anisotropic filler and the component having directionality to prepare a mixture; applying the mixture on a material and controlling the directionality in which the anisotropic filler is dispersed; and curing the applied material.

In the mixing, the anisotropic filler and the component having directionality are irregularly and randomly dispersed.

However, in the case of applying the mixture, the liquid crystal oligomer and the liquid crystal polymer, which are components having directionality and including the group that is not bent but has excellent linear property, are orientated in the predetermined direction. In this case, the anisotropic filler which is randomly mixed is dispersed in the same direction as the direction in which the component having directionality is orientated. Therefore, the directionality in which the anisotropic filler having the asymmetric structure is dispersed is controlled, thereby securing stability in which the mixture is dispersed.

Here, the component having directionality has the length in the range of 1.5 to 20 based on the length of the anisotropic filler, which is preferred to control the directionality in which the anisotropic filler is dispersed. In addition, in the case in which a range is out of the above-described range, it may be difficult to secure the dispersibility of the anisotropic filler.

Then, the applied material may be cured at an appropriate temperature to prepare the composite material such as a film.

In addition, in the exemplary embodiment of the present invention, the substrate using the composite material as the insulation layer may be provided.

The insulation layer according to the exemplary embodiment of the present invention is capable of having a thin thickness of 5-50 μm by securing the dispersibility of the anisotropic filler.

In addition, since the insulation layer according to the exemplary embodiment of the present invention may secure the filling rate of the anisotropic filler, the insulation layer may have a coefficient of thermal expansion of 0 to 50 ppm/K (0 is included in the exclusion of the coefficient of thermal expansion having negative (−) value).

The substrate including the insulation layer according to the exemplary embodiment of the present invention may minimize the defect that the insulation is easily dented, bent, or the like, by securing the coefficient of thermal expansion of the insulation layer even during a process at a high temperature for forming a multilayer circuit.

Hereinafter, preferred examples of the present invention will be described in detail. The examples below are just exemplary described, but the scope of the present specification and claims should not be interpreted as being limited to the examples. In addition, the examples below are exemplified using specific compounds, but it is obvious to those skilled in the art that an effect obtained by using equivalents thereof can be the same as or similar to that of the present invention.

### EXAMPLE

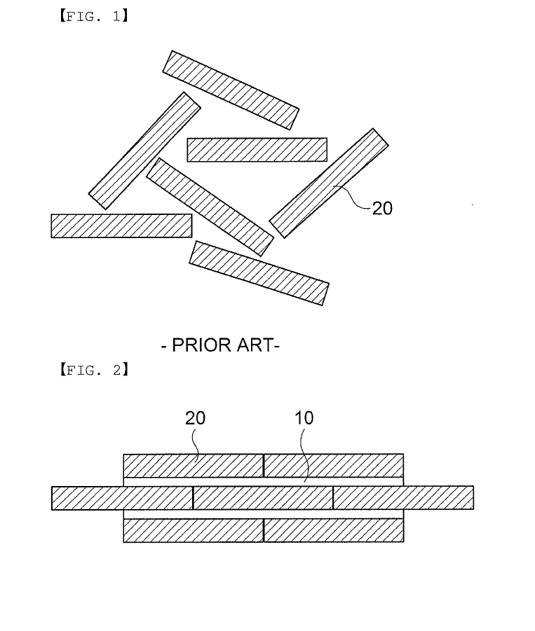

A component having directionality, wherein a length of the component having directionality is different from a length of an anisotropic filler as shown in the following FIG. 1, was used to prepare a composite material.

As the anisotropic filler, SiO₂ having a diameter of 0.2 m, a rod shape, an aspect ratio of 1.5 to 100 was used, and as the component having directionality, an oligomer having a biphenyl group was used. In addition, an epoxy resin is used as a base resin, and a ketone-based/alcohol-based mixed solvent was used as a solvent.

Further, a filling rate of the composite material prepared by using each of the samples was confirmed by measuring film density utilizing an Archimedes method and converting the density as a relative density based on the composition of the composite material, and results thereof were shown in the following Table 1.

TABLE 1

| | Length of Component Having | Filling Rate |
|---|---|---|
| Sample | Directionality Based on | of Composite |
| No. | Length of Anisotropic Filler | Material* |
| 1 | 0.5 | X |
| 2 | 1 | X |
| 3 | 1.5 | ◯ |
| 4 | 2 | ◯ |
| 5 | 5 | ◯ |
| 6 | 10 | ◯ |
| 7 | 15 | ◯ |
| 8 | 20 | ◯ |
| 9 | 25 | X |
| 10 | 30 | X |

*Filling Rate of Composite Material X: Defective (less than 40%), ◯: Good (40% or higher)

It may be appreciated from Table 1 below that in the case in which the length of the component having directionality based on the length of the anisotropic filler satisfies the range of 1.5 to 20 as described in the exemplary embodiment of the present invention, the dispersiblity of the anisotropic filler may be controlled, and the filling rate of the composite material may be improved.

As set forth above, according to the exemplary embodiment of the present invention, in the composite material using the anisotropic filler, the component having directionality is used for controlling the directionality in which the anisotropic filler is dispersed, whereby at the time of orientation of the component having directionality, the directionality in which the anisotropic filler is dispersed may be controlled to improve the dispersion of the anisotropic filler.

In addition, in the case in which the composite material according to the exemplary embodiment of the present invention is used as the insulation layer of the substrate, or the like, the insulation layer has high coefficient of thermal expansion by dispersion, such that the defect such as the warpage or the dent, or the like, may be minimized, and the substrate having excellent stiffness may be manufactured by securing a thinner insulation layer and using the anisotropic filler.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A composite material comprising:
an anisotropic filler; and
a component having directionality,
wherein the component having directionality has a length in a range of 1.5 to 20 based on a length of the anisotropic filler.

2. The composite material according to claim 1, wherein the anisotropic filler has an asymmetric structure.

3. The composite material according to claim 1, wherein the anisotropic filler has an aspect ratio of 1.5 to 100.

4. The composite material according to claim 1, wherein the anisotropic filler has a diameter of 0.01 to 1.0 m.

5. The composite material according to claim 1, wherein the anisotropic filler is at least one selected from a group consisting of SiO₂, Al₂O₃, ZrO₂, ZnO, BaO, CaO, MgO, and SrO.

6. The composite material according to claim 1, wherein the component having directionality is at least one selected from a liquid crystal polymer and a liquid crystal oligomer.

7. The composite material according to claim 1, wherein the component having directionality controls directionality in which the anisotropic filler is dispersed.

8. A method for preparing a composite material comprising:
mixing an anisotropic filler and a component having directionality;
applying the mixture on a film and controlling directionality in which the anisotropic filler is dispersed; and
curing the applied film.

9. The method according to claim 8, wherein the component having directionality has a length in a range of 1.5 to 20 based on a length of the anisotropic filler.

10. A substrate using an insulation layer comprising the composite material according to claim 1.

11. The substrate according to claim 10, wherein the insulation layer has a thickness of 5 to 50 μm.

12. The substrate according to claim 10, wherein the insulation layer satisfies a coefficient of thermal expansion of 0 to 50 ppm/K.
